(19) United States
(12) Patent Application Publication
(10) Pub. No.: US 2015/0183259 A1
(43) Pub. Date: Jul. 2, 2015

(54) ITEM FOR PHYSICIAN-PATIENT INTERACTION

(71) Applicant: Hospital Universitario San Ignacio, Bogota (CO)

(72) Inventors: Nick Antonio Tarazona Sanabria, Bogota (CO); Javier David Garay Fernández, Bogota (CO); Saúl Javier Rúgeles Quintero, Bogota (CO)

(21) Appl. No.: 14/583,440

(22) Filed: Dec. 26, 2014

(30) Foreign Application Priority Data
Dec. 27, 2013 (CO) 13.301.617

(51) Int. Cl. B42F 7/02

(52) U.S. Cl. CPC B42F 7/02

(57) ABSTRACT

The present utility model belongs to the field of medicine and consists of an item that facilitates interaction/communication between physicians and patients during the time different medical treatments that patients should undergo are performed and include stages within medical facilities and stages in the place of residence. Said item consists of a folder or ‘logbook’ that allows storing in an ordered fashion all elements that emerge during the time in which a patient should undergo a particular medical treatment and should be handled in a controlled manner to avoid communication errors between physicians and patients, and therefore for encouraging the development and successful completion of such medical treatment.

### CROSS-REFERENCE TO RELATED APPLICATION

This application claims priority to Colombian foreign patent application No. 13.301.617, filed on Dec. 27, 2013, the disclosure of which is incorporated by reference in its entirety.

### TECHNICAL BACKGROUND

The quality of the relationship between physicians and patients is important for both sides, because the better the relationship in terms of mutual respect, understanding, trust, shared values and perspectives on illness and life is, the better the knowledge that will be exchanged about the disease of the patient in both directions, improving the accuracy of diagnosis and increasing patient knowledge regarding the disease or illness.

Now, with the advent of more and better technologies favoring the medical treatment of people, and because of the noticeable advances that are occurring on the medical knowledge needed to achieve a comprehensive and successful management of patients during the time which they are subjected to complex medical treatments, as part of the interaction between physicians and patients, the urgent need for developing tools that allow physicians and patients to manage in a reliable and controlled manner all the elements that emerge as a result of placing these advances in technology and medical knowledge at the service of patients, has been growing.

Indeed, while complex medical treatments intended to address diseases or conditions in the most effective possible way are implemented, complications also appear in the controlled and reliable handling by physicians and patients of all the elements resulting from the implementation of such medical treatments, and overall, from the implementation of all the advances in the knowledge of integrated management of patients for achieving successful attention and/or recovery.

And it is undeniable the relevance that the conditions of interaction between physicians and patients have, for achieving a successful development and completion of different medical treatments, since otherwise, i.e., uncontrolled, confusing and disordered handling of the different elements that are part of the typical interaction between physicians and patients may seriously affect the results of the care process.

In addition to the above, there are additional situations that may further complicate the interaction between physicians and patients, including the commonly advanced age of patients and therefore the physical and mental limitations of such patients to perform an effective control of different elements arising during medical treatment or treatments to which they are subjected.

Now, some tools designed to facilitate in different ways the patient-physician interaction are known in the state of the art. Thus, for example, the United States Patent Application US 2010/0258613 discloses a system for quickly alerting medical emergency personnel to a medical history of a patient in the event of an emergency comprising: i) a primary identifier suitable for attachment near an entrance to a building wherein said primary identifier comprises an indicia noting a tri-fold portfolio is present; ii) a secondary identifier suitable for placement in said building wherein said secondary identifier comprises said indicia and a location of said tri-fold portfolio; and iii) said tri-fold portfolio comprising an outer portion with a top front cover, and bottom front cover, with a back hingedly attached there between; and cascading file folders attached to an interior of said back element.

On the other hand, the method disclosed in the Patent document US 2010/0258613 comprises the following steps: i) providing a tri-fold portfolio, ii) entering medical information on said tri-fold portfolio indicating the presence of detailed medical records stored in said cascading file folders, iii) entering said detailed medical records in said cascading file folders, iv) attaching a primary identifier to said building near an entrance, v) attaching a secondary identifier to a visible location in said building, vi) reviewing said primary identifier when entering said building, vii) searching for said secondary identifier and reviewing said location contained thereon and viii) locating said tri-fold portfolio containing said medical information.

From the above it is clear that although the medical management system disclosed in the patent application US 2010/0258613 was designed to allow the grouping of elements necessary for a health professional to exercise proper control over the management of a patient, such system does not allow achieving an adequate interaction between physicians and patients during the time and the proper conditions of a full medical treatment.

On the other hand, the patent application US 2001/0021339 refers to a file folder with tabs or identification tabs, and more particularly to file folders that can be individually printed. According to the authors of said prior art document, the file folder disclosed there is suitable for customized printing of information that identifies the type of documents stored there on both sides of the identification tab.

Specifically, the patent application US 2001/0021339 discloses a file folder that can be passed through a printer, having identifying information printed on both surfaces of the sheet or identifying tab and also on other surfaces in the folder.

From the above, it is clear that the folder disclosed in said prior art document allows effective control of the type of items stored there, however its configuration does not favor in any way the interaction between a group of people who, as happens in physician-patient relationships, requires to be permanently and orderly sharing items that come from different sources and which must be added to the previously existing elements.

Considering the above, it is clear that in the state of the art remained the need for developing an item whose configuration allowed to optimize the interaction between physicians, patients and/or relatives of patients throughout the time course of medical treatment, and even during pre and post phases of such medical treatment, thus promoting better communication between the parties involved and greater control of all the elements that arise during physician-patient interaction.

### BASIC FEATURES OF THE INVENTION

Now, given the teachings of the prior state of the art and based on the technical features of the different types of products already disclosed in the prior art, that have been created to promote the care of a patient during a particular medical treatment (planned or emergency), applicants of the present invention have developed a novel tool for interaction between physicians and patients who can effectively control all the elements that emerge as part of a medical treatment to which a patient is subjected, and whose management by the parties involved (, physicians, patients and relatives) depends largely on the success of the treatment.

Said Item was the result of clinical experience the inventors have had in front of the requirements usually observed in patients during their process of medical care, as well as in front of the requirements of medical personnel to attend promptly and accurately the different phases of medical treatment that a patient undergoes.

In this regard, the applicant of the concerned invention developed an item basically comprised of a single sheet of material forming: i) a front cover with an outer face and an inner face, ii) a back cover with an inner face and outer face, and iii) a spine formed by two folds of said sheet. Now, as it will be evident from the detailed description given below, the specific configuration of such new item allows its easy handling by physicians, patients and patient relatives, creating an effective interaction between the parties and effective control of all elements that arise as part of medical treatment.

### DETAILED DESCRIPTION OF THE INVENTION

In addition to what was stated previously, the object of the present application and the technical advantages achieved by the inventors may be appreciated in detail by the subsequent description of the item for physician-patient interaction herein disclosed, by referring to the accompanying drawings, in which:

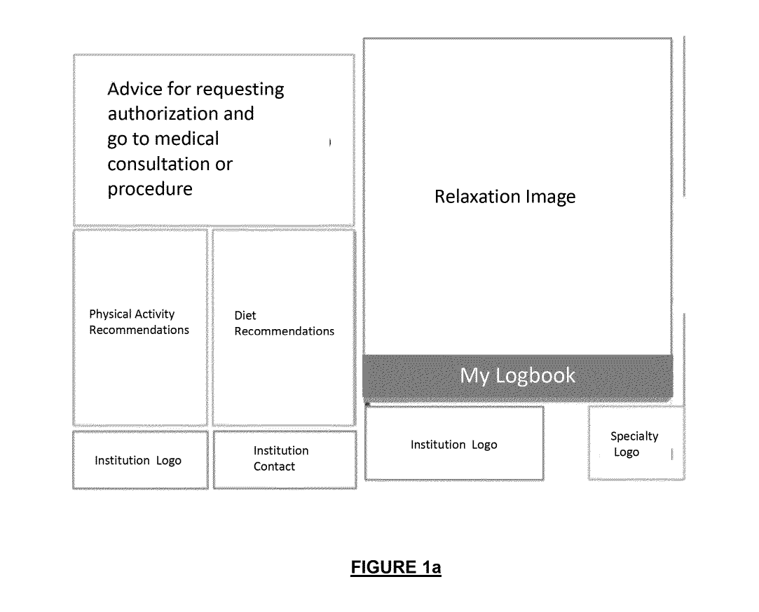

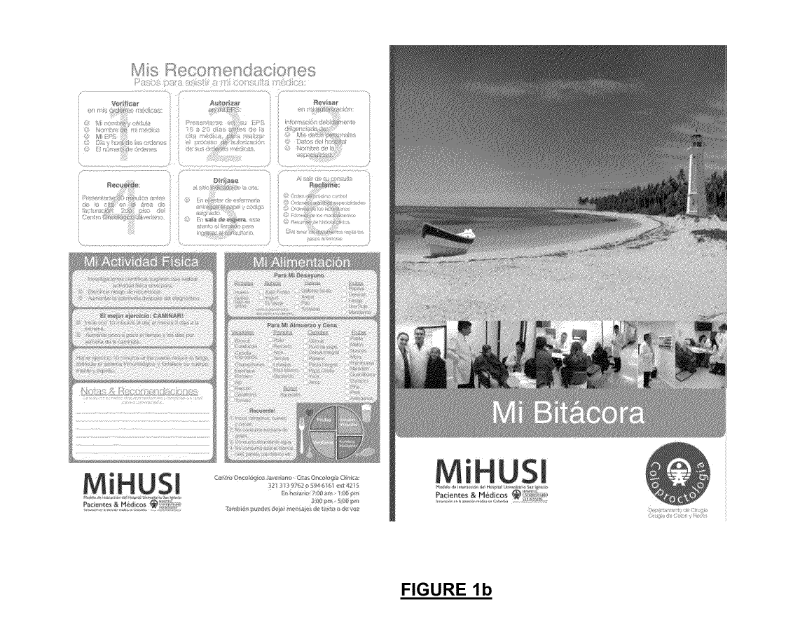

FIG. 1a shows a general configuration of the front and rear faces of the item for physician-patient interaction disclosed in the present invention.

FIG. 1b corresponds to the particular configuration of the front and rear faces of the item for physician-patient interaction disclosed in the present invention.

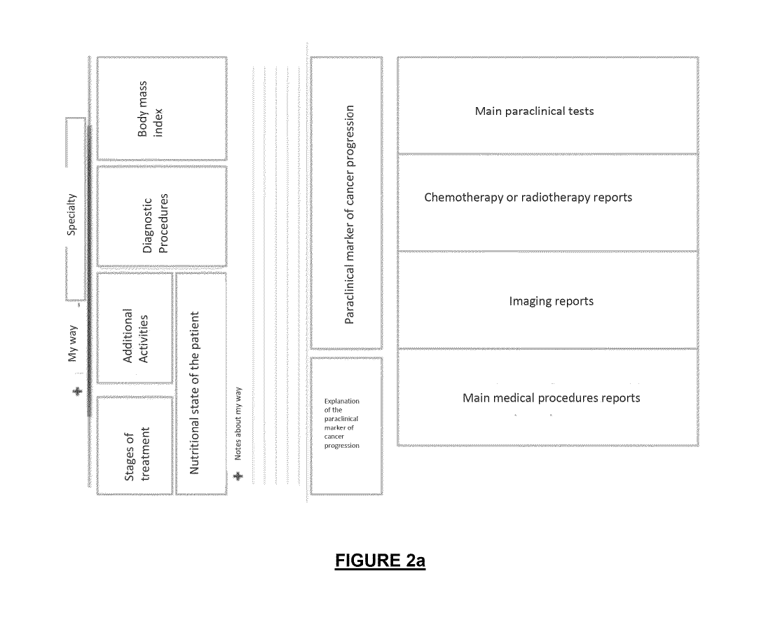

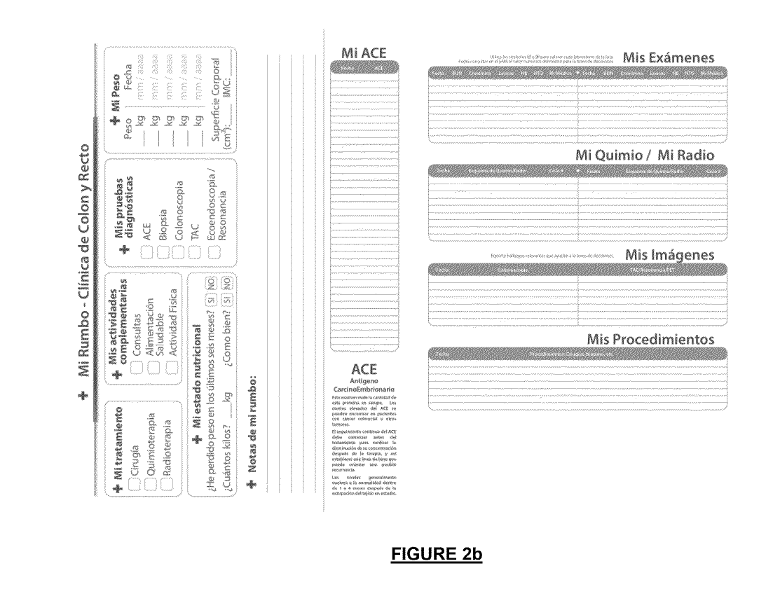

FIG. 2a shows a general configuration of the inner faces of the item for physician-patient interaction disclosed in the present invention.

FIG. 2b corresponds to a particular configuration of the inner faces of the item for physician-patient interaction disclosed in the present invention.

Now, referring to FIGS. 1a and 2a, the item disclosed in the present invention is formed by a front cover with an outer face and an inner face, a back cover with an inner face and an outer face, and a spine formed by two folds of said sheet, wherein:
i) The inner face of the back cover has a pocket with a front face having a form with spaces.
ii) The inner face of the front cover, and the inner and outer sides of the back cover have forms with spaces.

And more particularly:
i) The inner face of the back cover has a pocket (formed by a second sheet) with a front face having a form with spaces to store personal data of a patient and a treating physician;
ii) the inner face of the front cover has forms with spaces for storing data of the clinical course of the patient;
iii) the inner face of the back cover has forms with spaces for storing test data and/or medical procedures performed on the patient;
iv) the outer face of the back cover has forms with spaces for storing data of recommendations for the patient.

In a particular modality, the outer face of the front cover may include a representative picture of the specific medical service that the patient is using as well as additional images corresponding to typical activities of said medical service, or images of medical personnel that is in constant contact with patients.

The distribution of the contents in the here disclosed item of interaction is determined by each medical specialty or evaluated group, i.e., it is determined taking into account the needs related to, for example, tracking tests or the existence of key variables to identify during medical treatment that the patient is undergoing.

The possible contents of item for physician-patient interaction disclosed herein include the following:
1. Individual identification
   a. Patient Name
   b. Name of Physician
   c. Contact information
2. For improving the interaction of the log related to patients, is intended to provide order and understanding of the process of medical care such as for example:
   a. Examination follow-up
   b. Checklist for consultations and execution of medical tests
   c. Monitoring of relevant variables for their treatment
3. Recommendations for improving the interaction of patient and physician regarding the treatment process.
   a. Relevance to the processes and particular needs of patients according to the service they belong will be provided.
      i. For instance: Recommendations for the approval of medical appointments or procedures may be provided. Similarly, recommendations regarding diet and physical activity can play an important role in this section.

Likewise, the item for physician-patient interaction of the present invention may be further characterized because the front cover, back cover or both have representative colors of the disease or medical condition being treated, the above in order to facilitate even more the interaction between physician and patient, and to favor control the patient has on all the elements arising during the medical treatment which is undergoing.

However, due to its particular configuration, when the item disclosed in the present invention is used as part of the typical medical treatment activities, at least the following technical advantages for physicians, patients or both are obtained:
Generates a better understanding of patients about their disease, medical treatment which is undergoing and instructions to be followed outside medical facilities as part of the authorization process of medical procedures;
Efficient interaction between physicians and patient or relatives of the patient is triggered, where the latter are more involved in ongoing medical treatment and an additional therapeutic aspect, beneficial for the patient is created;
Enhances the efficacy of medical consultations and the optimal solution of questions asked by physicians to patients;
Reduces levels of stress and anxiety in patients by being well informed and have ordered and controlled all the elements arising during the medical treatment which are undergoing;
Promotes proper care of patients by physicians and families;
Allows giving a proper management of the various diagnostic images that arise as part of ongoing medical treatment; and,
Allows to get optimal medical monitoring of patients;

Although a particular embodiment of the invention has been disclosed in detail for illustrative purposes, it will be recognized that variations or modifications to the embodiment are within the scope of the present invention.

What is claimed is:

1. An item for controlling the interaction between physicians and patients during medical treatment characterized in that said item is a material sheet configured to include a front cover with an outer face and an inner face, a back cover with an inner face and an outer face and a spine formed by two folds of said sheet, and wherein further:
a) the inner face of the back cover has a pocket (formed by a second sheet) with a front face having a form with spaces for the physician to be quickly aware of the patient's name.
b) the inner face of the front face and the inner and outer sides of the back cover have forms with spaces to describe the process and the evolution of the patient management.

2. The item of claim 1 further characterized because:
i) the inner face of the front cover has forms with spaces for storing data of the clinical course of the patient;
ii) the inner face of the back cover has forms with spaces for storing test data and/or medical procedures performed on the patient; and,
iii) the outer face of the back cover has forms with spaces for storing data of recommendations for the patient.

3. The item of claim 1 wherein the outer face of the front cover includes a representative image of the specific medical service that the patient is using as well as additional images corresponding to medical service typical activities, or images of medical staff that is in constant contact with patients.

4. The item of claim 1 wherein the distribution of content in said item is determined by each group or medical specialty evaluated, taking into account the specific needs generated during medical treatment that a particular patient is undergoing.

5. The item of claim 1 further characterized because the front cover, back cover or both have representative colors of the disease or medical condition being treated.
